(19) United States
(12) Patent Application Publication
(10) Pub. No.: US 2008/0178257 A1
(43) Pub. Date: Jul. 24, 2008

(54) METHOD FOR INTEGRITY METRICS MANAGEMENT

(76) Inventors: Takuya Mishina, Yamato-shi (JP); Seiji Munetoh, Kawasaki-shi (JP); Megumi Nakamura, Yamato-shi (JP); Sachiko Yoshihama, Kawasaki-shi (JP)

Correspondence Address: SHIMOKAJI & ASSOCIATES, P.C., 8911 RESEARCH DRIVE, IRVINE, CA, 92618, US

(21) Appl. No.: 11/625,323

(22) Filed: Jan. 20, 2007

(51) Int. Cl. H04L 9/32

(52) U.S. Cl. 726/2

(57) ABSTRACT

A system for recording an expected value which a hash value of each of a plurality of the components in this system should take on. The system further records in association with secret information an expected value of integrity information which serves as a condition for permitting access to the secret information. The system includes a register for storing integrity information for certifying the integrity of the components. In the system, a value computed by further inputting to a hash function the expected values which hash values of the components should take on is stored in the register as the integrity information before the components are started. Then, a hash value of a component newly started is computed, and the integrity information of the register is updated on condition that the computed hash value is different from the expected value. Access to the secret information is permitted on condition that the expected value of the integrity information and the integrity information of the register are identical.

### BACKGROUND OF THE INVENTION

The present invention relates to a system for controlling access to secret information. In particular, the present invention relates to a system for preventing the leakage of secret information caused by the tampering with the system.

In recent years, technologies of data encryption and electronic signatures are becoming indispensable to information communications. Encryption and electronic signatures require secret information such as a cryptographic key. This secret information must be managed so as not to be leaked to an outsider. Accordingly, in many cases, secret information is stored in a storage area in a storage device which only an administrator thereof can access. However, in the case where communication software which uses the secret information has been tampered with by a malicious user, the secret information may be leaked against the intention of the administrator.

To cope with this problem, the technology of determining the integrity of a software component has been used heretofore. For example, this technology is used in software for inspecting computer viruses. However, in this technology, it is difficult to determine whether or not the integrity of software itself for realizing this technology is maintained. That is, for example, in the case where the software itself for inspecting computer viruses is infected by a computer virus, it is difficult to determine the integrity of the inspection software.

On the other hand, the technology of determining the integrity of software using hardware has been proposed (see TCG Trusted Computing Group web page, https://www.trustedcomputinggroup.org/home). In this technology, an LSI chip called a Trusted Platform Module (TPM) is mounted in an information processing device. By a process performed by the TPM, the integrity of software which operates on the information processing device is determined. Secret information is protected by the TPM, and the readout thereof is permitted on condition that the integrity has been authenticated. Thus, the integrity of software can be appropriately determined.

The TPM includes a register (PCR: Platform Configuration Register) for storing integrity information for certifying the integrity of software. In the TPM, access to the PCR is physically limited. That is, even if a malicious user tries to disassemble the information processing device, he or she cannot read the value of the PCR. Moreover, the TPM permits only a specific operation for the PCR. For example, this operation is called “Extend” and specifically expressed as the following equation:

PCR(n)=Hash(PCR(n−1)+Digest)

Here, PCR(n−1) is the value of the PCR before the Extend operation. Digest is a hash value of a certain software component. Hash( ) is a function for computing a hash value. PCR(n) is the value of the PCR after the Extend operation. As to a specific processing procedure, at the power on reset time, the TPM first substitutes zero for the PCR. When a software component is started, then the integrity of software components are measured by special boot sequence called “Trusted Boot”. A hash value to the variable Digest of the each software component is computed before execution by previous stage of software component, and performs the above-described Extend operation using the hash value. The software component repeats this process every time. The first software component computes own hash value and Extend itself, thus this components must be write protected.

As a result, a value determined according to the combination of a plurality of software components started and the start-up sequence thereof is stored in the PCR. This value is computed by a hash function, which is a one-way function, and is therefore difficult to forge. Furthermore, the probability that a value identical with this value will be generated by chance is also very low.

However, in a system in which a large number of software components are configured in a complicated manner, there are cases where the start-up sequence of the software components changes every time the system is started. In such a case, a TPM mounted in the system generates a different value every time the system is started, and stores the value in a PCR. Accordingly, in this system, the value of the PCR to be obtained when the integrity of the software components is maintained cannot be statically computed in advance. Thus, access to secret information protected by the value of the PCR cannot be appropriately controlled in a state in which some of the software components are not started.

Furthermore, the TPM records Digest used for the Extend operation in a log called a Stored Measurement Log (SML). That is, every time a software component is started, the TPM updates the value of the PCR based on a hash value of the software component, and adds the hash value to the SML. If hash values in the SML are referred to, it is considered that the integrity of each software component started can be determined. However, the readout of secret information is currently controlled by the PCR. If an attempt is made to control secret information using the SML, the TPM needs to be extensively modified. Moreover, even if such a modification can be made, the data size of the SML is larger than that of the PCR. Thus, the manufacturing costs and power consumption of the TPM increase greatly.

It should be noted that a technology has been proposed heretofore in which the data size of an SML is reduced by not updating the SML in the case where a software component which has been started once is started again (see R. Sailer, X. Zhang, T. Jaeger, and L. van Doorn, “Design and Implementation of a TCG-based Integrity Measurement Architecture.” Thirteenth USENIX Security Symposium, pages 223-238, August 2004). However, even with this technology, the data size of the SML is larger than that of the PCR, and application for controlling the readout of secret information is difficult.

### BRIEF SUMMARY OF THE INVENTION

Accordingly, one exemplary aspect of the present invention is a system for controlling access to secret information. The system includes an expected value recording unit for recording an expected value which a hash value of each of a plurality of predetermined components should take on in a case where the component is valid. The plurality of predetermined components are included in the system. System further includes a register for storing integrity information for certifying integrity of the plurality of components. An integrity information managing unit stores a value, which is computed by further inputting the expected values to a hash function, as the integrity information in the register in advance before the plurality of components are started. An integrity information updating unit computes, in response to start-up of any of the components, a hash value of the component, and updates the integrity information stored in the register on condition that the computed hash value is different from the expected value recorded in the expected value recording unit in association with the component. A secret information recording unit records an expected value of the integrity information in association with the secret information. The expected value of the integrity information serves as a condition for permitting access to the secret information. A comparing unit compares the expected value recorded in association with the secret information with the integrity information stored in the register, in response to an access request to the secret information. An access controlling unit permits access to the secret information on condition that the integrity information and the expected value of the integrity information are identical with each other, and prohibiting access to the secret information on condition that the integrity information and the expected value of the integrity information are different from each other.

Another exemplary aspect of the invention is a method of controlling access to secret information, using a system for controlling access to the secret information. The system includes an expected value recording unit for recording an expected value which a hash value of each of a plurality of predetermined components should take on in a case where the component is valid, the plurality of predetermined components being included in the system; a register for storing integrity information for certifying integrity of the plurality of components; a integrity information managing unit for storing a value, which is computed by further inputting the expected values to a hash function, as the integrity information in the register in advance before the plurality of components are started; and a secret information recording unit for recording a value of the integrity information in association with the secret information, the value of the integrity information serving as a condition for permitting access to the secret information. The method includes, in response to start-up of any of the components, computing a hash value of the component, and updating the integrity information stored in the register on condition that the computed hash value is different from the expected value recorded in the expected value recording unit in association with the component. A recording operation, in association with the secret information, records the expected value of the integrity information serving as the condition for permitting access to the secret information. A comparing operation, in response to an access request to the secret information, compares the expected value recorded in association with the secret information with the integrity information stored in the register. A permitting operations permits access to the secret information on condition that the integrity information and the expected value of the integrity information are identical with each other, and prohibiting access to the secret information on condition that the integrity information and the expected value of the integrity information are different from each other.

Yet another aspect of the invention is a program stored on computer readable medium for causing an information processing device to function as a system for controlling access to secret information. The program causes the information processing device to function as: an expected value recording unit for recording an expected value which a hash value of each of a plurality of predetermined components should take on in a case where the component is valid, the plurality of predetermined components being included in the system; a register for storing integrity information for certifying integrity of the plurality of components; a integrity information managing unit for storing a value, which is computed by further inputting the expected values to a hash function, as the integrity information in the register in advance before the plurality of components are started; a integrity information updating unit for computing, in response to start-up of any of the components, a hash value of the component, and updating the integrity information stored in the register on condition that the computed hash value is different from the expected value recorded in the expected value recording unit in association with the component; a secret information recording unit for recording an expected value of the integrity information in association with the secret information, the expected value of the integrity information serving as a condition for permitting access to the secret information; a comparing unit for comparing the expected value recorded in association with the secret information with the integrity information stored in the register, in response to an access request to the secret information; and an access controlling unit for permitting access to the secret information on condition that the integrity information and the expected value of the integrity information are identical with each other, and prohibiting access to the secret information on condition that the integrity information and the expected value of the integrity information are different from each other.

### BRIEF DESCRIPTION OF THE SEVERAL VIEWS OF THE DRAWINGS

FIG. 1 shows the overall configuration of a communication network 10 contemplated by the present invention.

FIG. 2 shows the functional configuration of an information processing system 20 contemplated by the present invention.

FIG. 3 shows the functional configuration of a security chip 1015.

FIG. 4 shows one example of the data structure of a secret information recording unit 310.

FIG. 5 shows the functional configuration of a CPU 1000.

FIG. 6 shows one example of the data structure of an expected value recording unit 510.

FIG. 7 shows the processing flow of a process for managing integrity information and an expected value thereof by the information processing system 20.

FIG. 8 shows details of a process in S710 of FIG. 7.

FIG. 9 shows the processing flow of a process for updating expected values of hash values and an expected value of integrity information by the information processing system 20.

FIG. 10 shows the processing flow of a process in which the information processing system 20 limits access to secret information.

### DETAILED DESCRIPTION OF THE INVENTION

As will be appreciated by one skilled in the art, the present invention may be embodied as a method, system, or computer program product and makes it possible to control access to secret information recorded in an information processing device more efficiently than before. Accordingly, the present invention may take the form of software and hardware embodiments that may all generally be referred to herein as a “circuit,” “module” or “system.” Furthermore, the present invention may take the form of a computer program product on a computer-usable storage medium having computer-usable program code embodied in the medium.

Any suitable computer usable or computer readable medium may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, or a magnetic storage device.

Computer program code for carrying out operations of the present invention may be written in an object oriented programming language such as Java, Smalltalk, C++ or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

Hereinafter, the present invention will be described using an embodiment of the invention. However, the embodiment below is not intended to limit the invention commensurate with the scope of the claims, and all of combinations of features described in the embodiment are not necessarily essential for solving means of the invention.

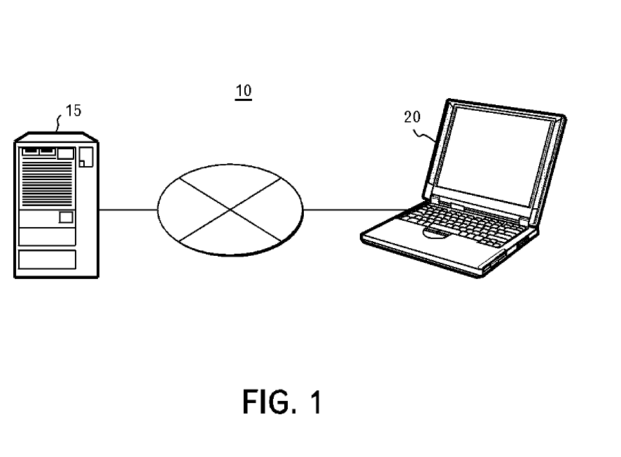

FIG. 1 shows the overall configuration of a communication network 10. The communication network 10 includes a server system 15 and an information processing system 20 connected to each other through a telecommunication line. The information processing system 20 has secret information recorded in a built-in storage device. The secret information is information managed not to be known to anyone other than an administrator of the information processing system 20. The secret information may be, for example, a secret key of a cipher for communications, or authentication information indicating that the information processing system 20 is a valid device. The information processing system 20 communicates with the server system 15 using this secret key or authentication information. The server system 15 authenticates the information processing system 20 using the authentication information received from the information processing system 20, or encrypts communications with the information processing system 20 using the encryption key received from the information processing system 20.

Here, in the case where software which operates on the information processing system 20 has been tampered with, unauthorized access to the server system 15 may occur against the intention of the user managing the information processing system 20. This unauthorized access may cause a problem such as the leakage or tampering with information on the server system 15. The information processing system 20 of this embodiment is intended to appropriately determine whether software which operates on the information processing system 20 is valid or not without using an external device such as the server system 15.

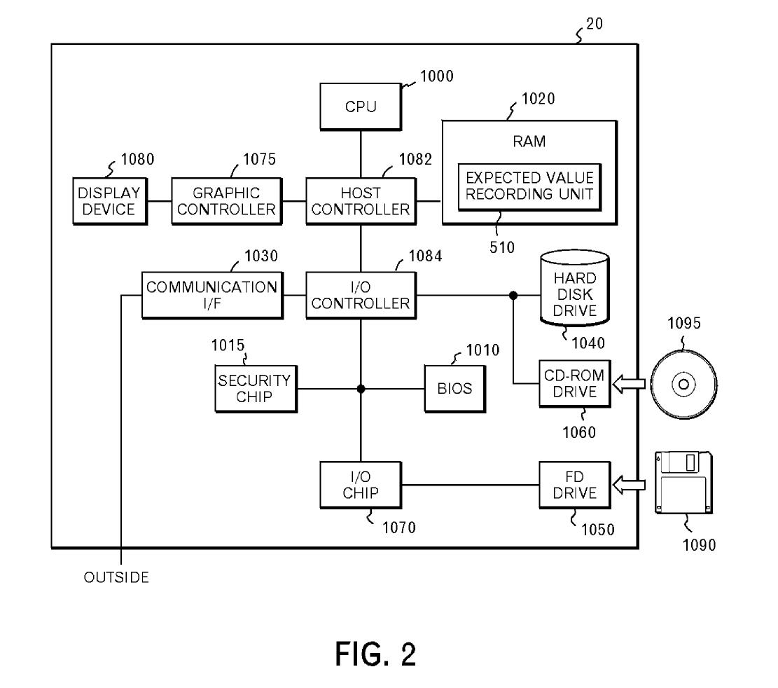

FIG. 2 shows the functional configuration of the information processing system 20. The information processing system 20 includes a CPU peripheral module including a CPU 1000, a RAM 1020, and a graphic controller 1075 which are connected to each other through a host controller 1082. Furthermore, the information processing system 20 includes an input/output module including a communication interface 1030, a hard disk drive 1040, and a CD-ROM drive 1060 connected to the host controller 1082 through an input/output controller 1084. Moreover, the information processing system 20 includes a legacy input/output module including a BIOS 1010, a flexible disk drive 1050, and an input/output chip 1070 connected to the input/output controller 1084.

The host controller 1082 connects the RAM 1020 to the CPU 1000 and the graphic controller 1075 which access the RAM 1020 at high transfer rates. The CPU 1000 operates based on programs stored in the BIOS 1010 and the RAM 1020, and controls each unit. For example, the RAM 1020 functions as an expected value recording unit 510. The expected value recording unit 510 records an expected value which a hash value of each of a plurality of predetermined software components (hereinafter, software components are simply referred to as components) should take on in the case where the component is valid, the plurality of predetermined software components being included in the information processing system 20.

Here, a hash value of a component is a value obtained by inputting the program code of the component to a predetermined hash function. Furthermore, the wording “the component is valid” means that the program code of the component has not been changed since the point in time when the component is determined to be valid by the administrator of the information processing system 20.

The graphic controller 1075 obtains image data which the CPU 1000 or the like generates on a frame buffer provided in the RAM 1020, and produces a display on a display device 1080. The input/output controller 1084 connects the host controller 1082 to the communication interface 1030, the hard disk drive 1040, and the CD-ROM drive 1060 which are relatively fast input/output devices. The communication interface 1030 communicates through a network with an external device, e.g., the server system 15. The hard disk drive 1040 stores programs and data which the information processing system 20 uses. The CD-ROM drive 1060 reads a program or data from the CD-ROM 1095, and provides the program or data to the RAM 1020 or the hard disk drive 1040.

Furthermore, to the input/output controller 1084, connected are the BIOS 1010, a security chip 1015, and the flexible disk drive 1050, the input/output chip 1070, and the like which are relatively slow input/output devices. The BIOS 1010 stores a boot program executed by the CPU 1000 at the start-up of the information processing system 20, programs depending on the hardware of the information processing system 20, and the like. The security chip 1015 records the secret information, and permits access to the secret information on condition that the integrity of the information processing system 20 has been certified. The flexible disk drive 1050 reads a program or data from a flexible disk 1090, and provides the program or data to the RAM 1020 or the hard disk drive 1040 through the input/output chip 1070. To the input/output chip 1070, connected are the flexible disk 1090 and various kinds of input/output devices through, for example, a parallel port, a serial port, a keyboard port, and a mouse port.

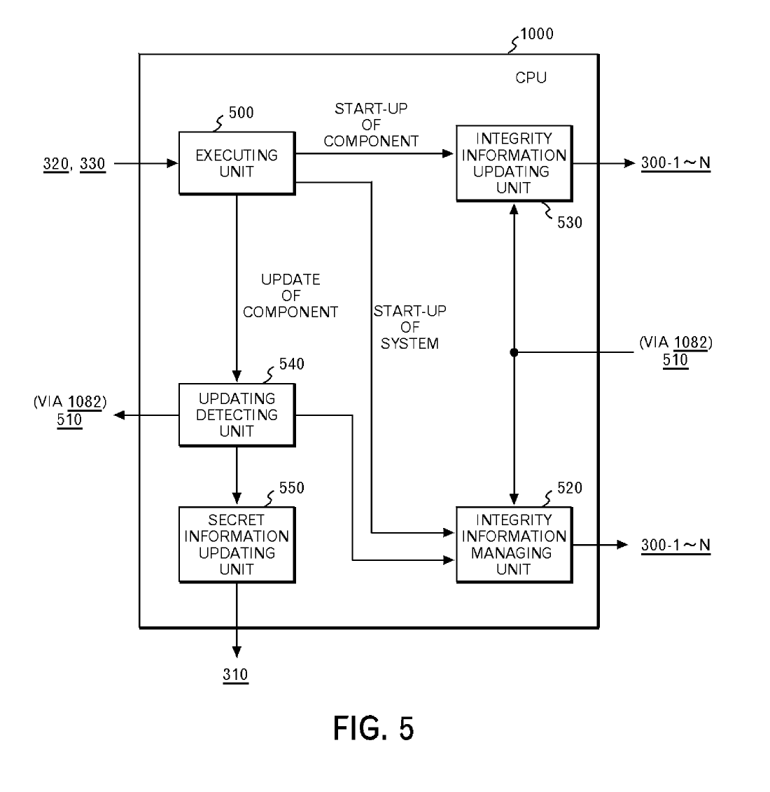

A program provided to the information processing system 20 is provided by a user in a state in which it is stored on a recording medium such as the flexible disk 1090, the CD-ROM 1095, or an IC card. The program is read from the recording medium through the input/output chip 1070 and/or the input/output controller 1084, installed on the information processing system 20, and executed. An operation which the information processing system 20 or the like to perform upon being actuated by the program will be described later using FIG. 5.

The program may be stored on an external storage medium. Other than the flexible disk 1090 and the CD-ROM 1095, an optical recording medium such as a DVD or a PD, a magneto-optical recording medium such as an MD, a tape medium, a semiconductor memory such as an IC card, or the like can be used as the storage medium. Alternatively, the program may be provided to the information processing system 20 through a network using as the recording medium a storage device such as a hard disk drive or a RAM which is provided in a server system connected to a dedicated communication network or the Internet.

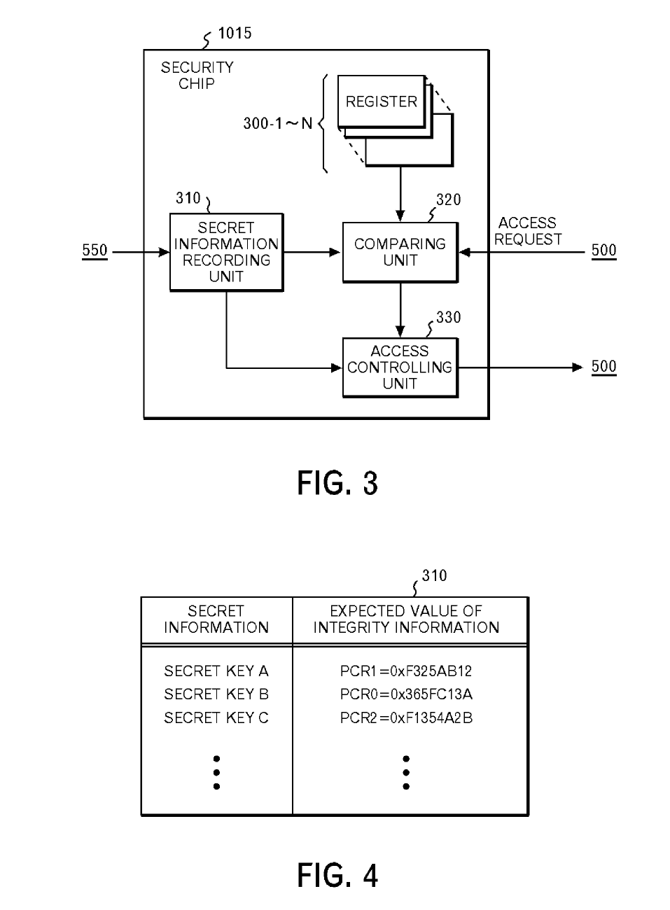

FIG. 3 shows the functional configuration of the security chip 1015. The security chip 1015 includes registers 300-1 to 300-N, a secret information recording unit 310, a comparing unit 320, and an access controlling unit 330. Each of the registers 300-1 to 300-N is provided in order to store integrity information for certifying the integrity of a plurality of predetermined components included in the information processing system 20. The registers 300-1 to 300-N have approximately the same functions, except for the difference in the components of which integrity is certified according to the certification information stored therein. Accordingly, the registers 300-1 to 300-N are generically called a register 300, and the description below will be given for the register 300, except for points of difference.

Here, the integrity of a plurality of components means that each of the plurality of components is valid. If all the components are valid, the integrity of the plurality of components is satisfied. On the other hand, if at least any one of the components is invalid, the integrity of the plurality of components is not satisfied.

The secret information recording unit 310 records in association with secret information an expected value of integrity information serving as a condition for permitting access to the secret information. This expected value may be updated by a secret information updating unit 550 described later. The comparing unit 320 receives an access request to secret information from software or the like which is being executed by an executing unit 500 described later. Furthermore, in response to the access request, the comparing unit 320 compares the expected value recorded in the secret information recording unit 310 in association with the secret information with the integrity information stored in the register 300. The access controlling unit 330 permits access to the secret information on condition that the integrity information and the expected value of the integrity information are identical with each other, and prohibits access to the secret information on condition that the integrity information and the expected value of the integrity information are different from each other. Specifically, the access controlling unit 330 reads the secret information from the secret information recording unit 310 to transmit the secret information to the executing unit 500 in the case where the access controlling unit 330 permits access, and notifies the secret information updating unit 550 of the prohibition of access in the case where the access controlling unit 330 prohibits access.

FIG. 4 shows one example of the data structure of the secret information recording unit 310. The secret information recording unit 310 records, in association with each of a plurality of pieces of secret information, an expected value of integrity information serving as a condition for permitting access to the piece of secret information. Secret information is, for example, a secret key for decrypting encrypted digital contents. The secret information recording unit 310 may record a plurality of different secret keys (secret keys A to C). Furthermore, the secret information recording unit 310 may record an expected value of integrity information in association with the identification information of the register 300 which is to be compared with the expected value. For example, the secret information recording unit 310 records an expected value “PCR1=0xF325AB12” in association with secret key A. This PCR1 is identification information indicating the register 300-2. That is, this indicates that the storing of “0xF325AB12” as integrity information in the register 300-2 is needed to permit access to secret key A. In the description below, the identification information of the register 300-1, that of the register 300-2, and that of the register 300-3 are assumed to be PCR0, PCR1, and PCR2, respectively.

FIG. 5 shows the functional configuration of the CPU 1000. The CPU 1000 functions as the executing unit 500, a integrity information managing unit 520, a integrity information updating unit 530, an update detecting unit 540, and the secret information updating unit 550 upon being actuated by a program. It should be noted that the respective functions of the integrity information managing unit 520, the integrity information updating unit 530, the update detecting unit 540, and the secret information updating unit 550 may be realized by modules of an operating system, by the BIOS program, or by an application program which operates on the operating system.

The executing unit 500 makes the BIOS, the operating system, application programs, and the like operate. The integrity information managing unit 520 obtains the respective expected values of hash values of a plurality of predetermined components from the expected value recording unit 510. Furthermore, the integrity information managing unit 520 records, as integrity information, a value computed by inputting these expected values to a hash function in the register 300 in advance before the plurality of components are started.

In response to the start-up of any of the plurality of components, the integrity information updating unit 530 computes a hash value of the component. Furthermore, the integrity information updating unit 530 updates the integrity information stored in the register 300 on condition that the computed hash value is different from the expected value recorded in the expected value recording unit 510 in association with the component. The update detecting unit 540 detects that any of the plurality of components has been updated. For example, the update detecting unit 540 may detect an upgrade of the component by monitoring the operation of the executing unit 500 and detecting the uninstallation and installation of software. Alternatively, the update detecting unit 540 may receive from a user of the information processing system 20 an input indicating that the component has been updated.

In response to the update of the component, the integrity information managing unit 520 computes respective hash values of the plurality of components, and generates integrity information based on the computed hash values to store the integrity information in the register 300. According to the integrity information generated in response to the update of the component, the secret information updating unit 550 updates the expected value of the integrity information recorded in the secret information recording unit 310 in association with secret information.

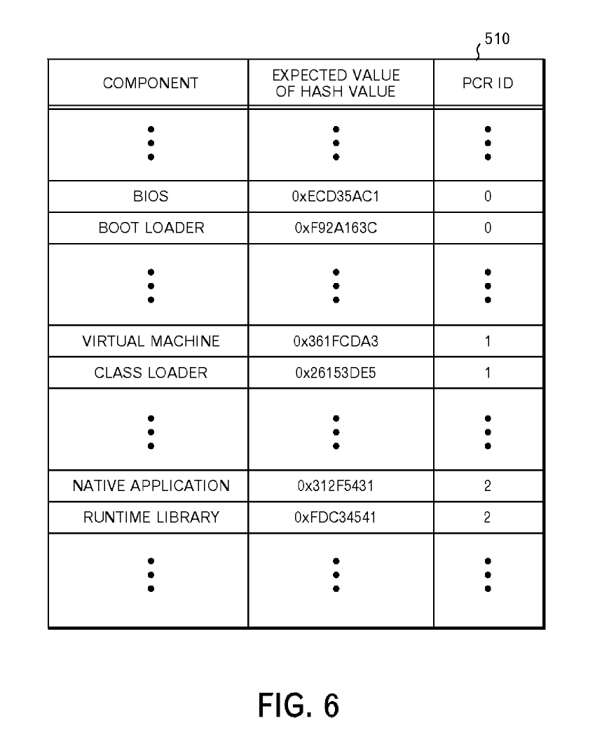

FIG. 6 shows one example of the data structure of the expected value recording unit 510. The expected value recording unit 510 records an expected value which a hash value of each of a plurality of predetermined components should take on in the case where the component is valid, the plurality of predetermined components being included in the information processing system 20. The plurality of predetermined components are desirably a set of components necessary for normally operating the information processing system 20. For example, the expected value recording unit 510 records a hash value generated from the program code of the “BIOS,” which is a component included in the information processing system 20, in association with the “BIOS.” It should be noted that the “BIOS” and a “boot loader” are components necessary for the operation of the operating system. Moreover, in this drawing, the expected value recording unit 510 records the names of components for convenience of explanation. Instead of this, the expected value recording unit 510 may record the identification information of components.

Furthermore, the expected value recording unit 510 records a hash value “0x361FCDA3” generated from the program code of a “virtual machine,” which is a component included in the information processing system 20, in association with the “virtual machine.” Here, the “virtual machine” is, for example, a virtual machine written in Java®, and functions as an interpreter or a compiler which makes a Java® program operate on the CPU 1000. It should be noted that the “virtual machine” and a “class loader” are components constituting middleware which operates on the operating system.

Also, the expected value recording unit 510 records a hash value “0x312F5431” of a “native application,” which is a component included in the information processing system 20, in association with the “native application.” The expected value recording unit 510 further records an expected value of a hash value of a “runtime library” which is read by the native application during the operation of the native application.

Moreover, it is preferable that the expected value recording unit 510 further records, in association with each component, the identification information of the register which stores integrity information for certifying that the component is valid. For example, PCR1 stores a value obtained as the result of further inputting the hash values of the “virtual machine” and the “class loader” to another hash function. On the other hand, PCR2 stores a value obtained as the result of further inputting the hash values of the “native application” and the “runtime library” to another hash function.

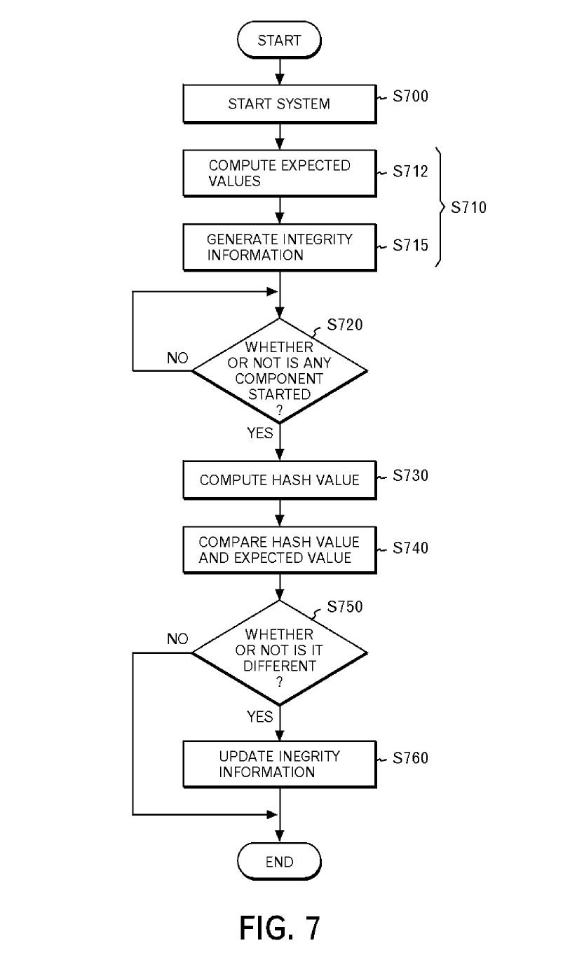

FIG. 7 shows the processing flow of a process for managing integrity information and an expected value thereof by the information processing system 20. When the information processing system 20 is started (S700), the integrity information managing unit 520 computes a hash value of each of a plurality of predetermined components to record the hash value as an expected value of the hash value in the expected value recording unit 510 (S712), regardless of whether or not the plurality of components have been started. Furthermore, the integrity information managing unit 520 generates integrity information based on the recorded hash values to store the integrity information in the register 300 (S715).

As one example, the integrity information is generated by an Extend operation expressed as the following equation:

Extend Operation: PCR(n)=Hash(PCR(n−1)+Digest)

Here, PCR(n−1) is the value of PCR before the Extend operation. Digest is a hash value of a certain component. Hash( ) is a hash function for generating integrity information. The integrity information managing unit 520 first resets the value of the register 300 to zero. This value is assigned to PCR(0). Then, the integrity information managing unit 520 performs an Extend operation using a hash value of a first component selected from the plurality of predetermined components in a predetermined sequence. This makes PCR(1) have a nonzero value based on the hash value of the first component. Extend operations are subsequently performed in the predetermined sequence one after another. A value obtained after Extend operations have been performed on all the predetermined components is the integrity information.

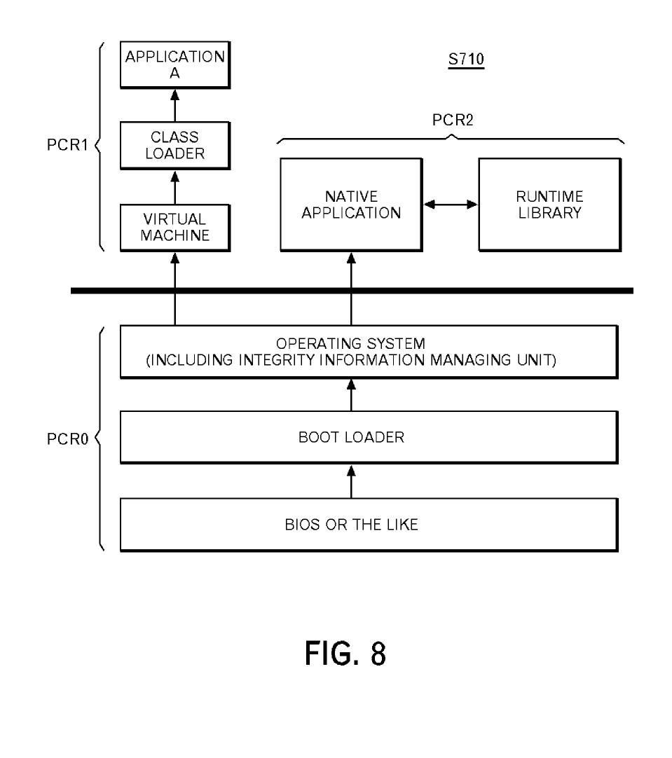

It should be noted that in the case where a plurality of registers are used, the above-described process is performed on each register, whereby integrity information is stored in each register. Details of this process will be described using FIG. 8.

Next, the integrity information updating unit 530 determines whether or not any of the plurality of predetermined components has been started (S720). In response to the start-up of any of the components (S720: YES), the integrity information updating unit 530 computes a hash value of the component (S730). Then, the integrity information updating unit 530 compares the computed hash value with the expected value recorded in the expected value recording unit 510 in association with the component (S740).

On condition that the hash value and the expected value are different from each other (S750: YES), the integrity information updating unit 530 updates the integrity information stored in the register 300 based on the hash value (S760). Specifically, the integrity information updating unit 530 performs an Extend operation on the register 300 using the hash value. That is, Hash(PCR(n−1)+Digest) is computed using the hash value as Digest and the value of the register 300 before the Extend operation as PCR(n−1), and the result of the computation is stored in the register 300.

FIG. 8 shows details of the process in S710 of FIG. 7. In this drawing, for the case where not only a single register but also a plurality of registers are used, a process for storing integrity information in the registers will be described. When the information processing system 20 is started, the executing unit 500 first starts the BIOS program. Then, the executing unit 500 starts the boot loader and the operating system in this order.

The integrity information managing unit 520 is realized as one function which the operating system includes. In response to the start-up of the operating system, the integrity information managing unit 520 computes hash values of components (e.g., the BIOS, the boot loader, and the operating system itself) necessary for the operation of the operating system. Then, the integrity information managing unit 520 records the computed hash values as expected values of the hash values in the expected value recording unit 510. Furthermore, the integrity information managing unit 520 generates integrity information based on the recorded hash values, and stores the integrity information in the register 300-1 (PCR0), which is a first register.

Moreover, the integrity information managing unit 520 computes hash values of components (e.g., a virtual machine, a class loader, and application program A) constituting middleware, and records the hash values in the expected value recording unit 510. Then, the integrity information managing unit 520 generates integrity information based on the recorded hash values, and stores the integrity information in the register 300-2 (PCR1), which is a second register. This process is performed before the components constituting the middleware are started. This makes it possible to control access to secret information based on the integrity of the middleware before the middleware is started.

In response to the start-up of any component necessary for the operation of the operating system, the integrity information updating unit 530 computes a hash value of the component. Then, the integrity information updating unit 530 updates the integrity information stored in the register 300-1 on condition that the computed hash value is different from the expected value recorded in association with the component at the start-up of the information processing system 20. This makes it possible to appropriately prohibit access to secret information even in the case where the component has been tampered with after the start-up of the information processing system 20.

Similarly, in response to the start-up of any component necessary for the operation of the middleware, the integrity information updating unit 530 computes a hash value of the component. Then, the integrity information updating unit 530 updates the integrity information stored in the register 300-2 (PCR2) on condition that the computed hash value is different from the expected value recorded in association with the component at the start-up of the operating system. This makes it possible to appropriately prohibit access to secret information even in the case where the middleware has been tampered with after the start-up of the operating system.

Furthermore, in response to the start-up of the native application, the integrity information updating unit 530 computes a hash value of the native application and a hash value of the runtime library which may be read during the operation thereof. Then, the integrity information updating unit 530 stores in the register 300-2 a value computed by further inputting these hash values to a hash function regardless of whether or not the runtime library has been read. This makes it possible to determine whether or not the application program properly operates in advance before the native application program starts operating.

It should be noted that the native application of this drawing is, for example, an application program for playing back digital contents. This application program plays back encrypted digital contents by obtaining a secret key recorded in the secret information recording unit 310 and decrypting the encrypted digital contents using the secret key. If this application program is tampered with, the secret key may be leaked to an outsider through a telecommunication line, or the decrypted digital content may be leaked. With this embodiment, the tampering of this application program is appropriately detected to prevent such leakage, and thus access to the secret key can be effectively prohibited.

As described above, by the process shown in this drawing, the information processing system 20 can appropriately determine the integrity of the components constituting the middleware regardless of whether or not the components constituting the middleware have been started. Similarly, the integrity of the runtime library can be appropriately determined regardless of whether or not the runtime library has been read by the application program. Furthermore, as to the components necessary for the operation of the operating system, by computing hash values thereof after the start-up of the operating system, the function of managing integrity information is centralized in the operating system, and thus the design of the entire information processing system 20 can be simplified.

Instead of this, as to the components (boot loader, BIOS, and the like) necessary for the operation of the operating system, hash values thereof may be computed before the start-up of the operating system. For example, the integrity information managing unit 520 may be realized as a function of the BIOS program or the like, and may generate expected values of the hash values and an expected value of integrity information in response to the start-up of the BIOS before the start-up of the operating system and the like. Such a configuration even makes it possible to determine the integrity of the operating system before the start-up thereof.

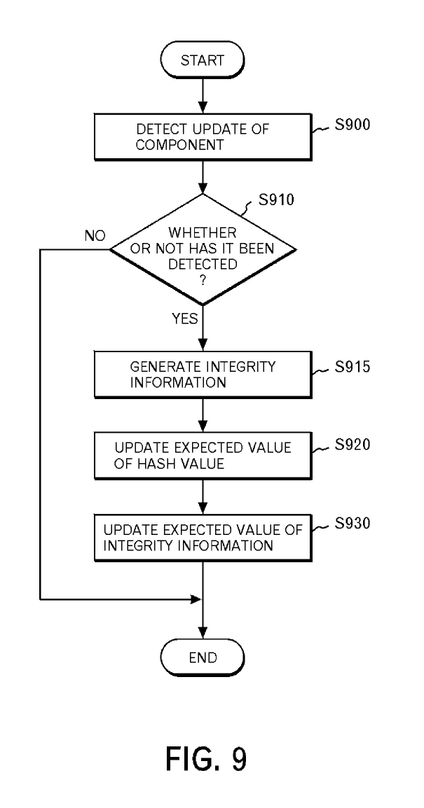

FIG. 9 shows the processing flow of a process for updating expected values of hash values and an expected value of integrity information by the information processing system 20. The update detecting unit 540 detects that any of a plurality of predetermined components has been updated (S900). Here, the update of a component is desirably performed according to instructions of an authenticated administrator or the like.

In response to the update of the component (S910: YES), the integrity information managing unit 520 computes a hash value of each of the plurality of components, and generates integrity information based on the computed hash values to store the integrity information in the register 300 (S915). Furthermore, the computed hash values are recorded in the expected value recording unit 510 (S920). The secret information updating unit 550 updates the expected value of the integrity information recorded in the secret information recording unit 310 in association with secret information according to the integrity information generated in response to the update of the component (S930).

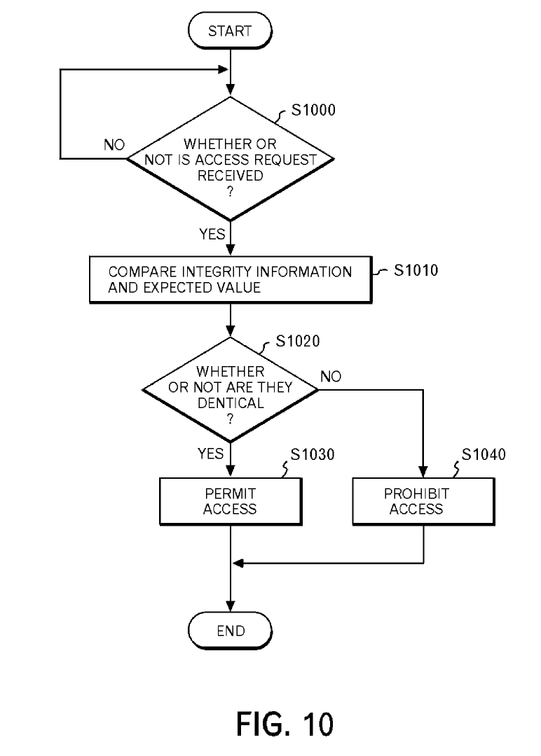

FIG. 10 shows the processing flow of a process in which the information processing system 20 limits access to secret information. The comparing unit 320 determines whether or not access to a secret key is requested by an application program or the like in order to play back digital contents (S1000). In response to an access request to secret information (S1000: YES), the comparing unit 320 compares the expected value recorded in the secret information recording unit 310 in association with the secret information with the integrity information stored in the register 300 (S1010).

The access controlling unit 330 permits access to the secret information (S1030) on condition that the integrity information and the expected value of the integrity information are identical with each other (S1010: YES). That is, for example, the access controlling unit 330 plays back digital contents by permitting access to the secret key. On the other hand, the access controlling unit 330 prohibits access to the secret information (S1040) on condition that the integrity information and the expected value of the integrity information are different from each other (S1020: NO). That is, for example, the access controlling unit 330 prohibits the playback of digital contents by prohibiting access to the secret information.

As described above, the information processing system 20 shown in this embodiment can determines the integrity of the entire system including a software component regardless of whether or not the software component has been started. This makes it possible to appropriately control access to secret information even before the start-up of the software component. Furthermore, even in the case where a plurality of software components are started in no particular order, access to secret information can be appropriately controlled by effectively utilizing the security chip for controlling access to the secret information.

It should be noted that the method of the present invention may be embedded in a program product, which includes all features for implementing the method of the present invention and can implement the method when it is loaded in a machine system.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to embodiments thereof, it will be apparent that modifications and variations are possible without departing from the scope of the invention defined in the appended claims.

1-9. (canceled)

10. A method of controlling access to secret information, using a system for controlling access to the secret information, wherein
the system comprises:
an expected value recording unit for recording an expected value which a hash value of each of a plurality of predetermined components should acquire in a case where the component is valid, the plurality of predetermined components being included in the system,
a register for storing authentication information for authenticating integrity of the plurality of components,
an authentication information managing unit for storing a value, which is computed by further inputting the expected values to a hash function, as the authentication information in the register in advance before the plurality of components are started, and
a secret information recording unit for recording a value of the authentication information in association with the secret information, the value of the authentication information serving as a condition for permitting access to the secret information, and
the method comprises:
a step to compute a hash value of the component in response to start-up of any of the components, and to update the authentication information stored in the register on condition that the computed hash value is different from the expected value recorded in the expected value recording unit in association with the component;
a step to record the expected value of the authentication information on condition for permitting access to the secret information, in association with the secret information;
a step to compare the expected value recorded in association with the secret information with the authentication information stored in the register, in response to an access request to the secret information; and
a step to permit access to the secret information on condition that the authentication information and the expected value of the authentication information are identical with each other, and to prohibit access to the secret information on condition that the authentication information and the expected value of the authentication information are different from each other.
